(19) United States
(12) Patent Application Publication
(10) Pub. No.: US 2014/0201031 A1
(43) Pub. Date: Jul. 17, 2014

(54) Electronic commerce gift shopping cart management system

(71) Applicant: Clayton Brooks, Irvine, CA (US)

(72) Inventor: Clayton Brooks, Irvine, CA (US)

(21) Appl. No.: 14/146,631

(22) Filed: Jan. 2, 2014

Related U.S. Application Data
(60) Provisional application No. 61/751,742, filed on Jan. 11, 2013.

(51) Int. Cl. G06Q 30/06

(52) U.S. Cl. CPC G06Q 30/0633
USPC 705/26.8

(57) ABSTRACT

A method of managing an electronic gift shopping cart includes the steps of: configuring a server to retrieve retailer product information and displaying the retailer product information to a gift giver, the retailer information comprising at least: a product name, a product SKU, and a product description; and presenting the retailer product information to a gift giver user; configuring the server to generate a first shopping cart state by receiving a gift giver gift selection from the retailer product information; configuring the server to configure parameters of the first shopping cart state including the step of providing a choice of a gift to a gift recipient so that a plurality of items provides a gift choice; and configuring the server to present the first shopping cart state to the gift recipient in the form of a gift notice.

This application is a nonprovisional patent application of provisional application 61/751,742 entitled Electronic Commerce Gift Shopping Cart Management System by same inventor Clayton Brooks filed Jan. 11, 2013.

### FIELD OF THE INVENTION

The present invention is in the field of electronic commerce, more specifically a method of managing a gift shopping cart.

### DISCUSSION OF RELATED ART

A variety of different electronic commerce methods have been applied to facilitate gift giving online. For example, U.S. Pat. No. 7,761,344 by Smith filed Aug. 28, 2007 issued Jul. 20, 2010 entitled Electronic Commerce Rule-Based Multi-Selection Gifting provides for a multi-selection gift where a gift giver gives a recipient a credit that can be used for a gift selection, the disclosure of which is incorporated herein by reference. Takahashi in United States patent publication 20020026377 published Feb. 28, 2002 entitled Gift Arrangement Method and System Therefore Using Internet also teaches a multi-selection gift as well as allowing the receiver to specify the method for receiving the gift. Unfortunately, implementation of the multi-selection gift is not widespread because it can have financial complications that lead to technical difficulties.

Cailens in United States patent publication 20060178969, published Aug. 10, 2006 provides offering a selection of at least one of a plurality of primary gifts within a set and a selection of one or more secondary gifts, the disclosure of which is incorporated herein by reference. Walker in U.S. Pat. No. 6,130,106 issued Oct. 24, 2000 entitled provides a concealed value gift certificate that allows gift selection and purchasing by the recipient, the disclosure of which is incorporated herein by reference. Oshima in United States patent publication 20030074265 published Apr. 17, 2003 entitled Gift Intermediating System and Method Therefore provides a server that operates an e-commerce gift registry, the disclosure of which is incorporated herein by reference.

### SUMMARY OF THE INVENTION

A method of managing an electronic gift shopping cart includes the steps of: configuring a server to retrieve retailer product information and displaying the retailer product information to a gift giver, the retailer information comprising at least: a product name, a product SKU, and a product description; and presenting the retailer product information to a gift giver user; configuring the server to generate a first shopping cart state by receiving a gift giver gift selection from the retailer product information; configuring the server to configure parameters of the first shopping cart state including the step of providing a choice of a gift to a gift recipient so that a plurality of items provides a gift choice; and configuring the server to present the first shopping cart state to the gift recipient in the form of a gift notice.

Further steps include: configuring the server to receive gift recipient input to modify the first shopping cart state to generate the second shopping cart state based upon the first shopping cart state, so that the gift recipient provides a gift selection which updates the shopping cart from the first shopping cart state to the second shopping cart state; configuring the server to assign parameters to the second shopping cart state; configuring the server to present the second shopping cart state to the gift giver; configuring the server to receive feedback and a final confirmation from the gift giver; configuring the server to generate a third shopping cart state based upon the second shopping cart state and gift giver feedback; and configuring the server to transmit the third shopping cart to the retailer for merchant processing with the retailer's server.

The method of managing an electronic gift shopping cart may also have the step of recommending a gift selection to a purchaser based upon prior gift recipient purchasing history.

It is also preferred to have the server sending messages from the gift recipient to the gift giver so that the gift giver has verification of gift receipt and also personalized feedback regarding the gift. The server preferably is configured for allowing the receiver to choose one out of several gift possibilities provided by the gift giver to generate a second shopping cart state. The server is also preferably configured for allowing the receiver to choose to allow the gift giver to choose the gift. The method of managing an electronic gift shopping cart preferably allows the receiver to reject the gift and also allows the receiver to customize a gift according to the gift parameters.

The method of managing an electronic gift shopping cart may allow the gift notice by e-mail but also the gift notice can be by a printed card having gift notice indicia with electronically readable indicia such as a QR code pointing to an access address hosted by the server. The step of providing a gift choice to a gift recipient may also allow defining a bundle of items as the gift choice. Here, the gift recipient provides the gift selection which updates the shopping cart from the first shopping cart state to the second shopping cart state.

One of the objects of the invention is to provide a gift selection to a gift recipient, while at the same time not requiring shopping cart processing until the gift selection is finalized.

### BRIEF DESCRIPTION OF THE DRAWINGS

FIG. 1 is a flowchart showing operation of the present invention by a server.

FIG. 2 is a diagram of an introductory website webpage hosted by the server.

FIG. 3 is a diagram of a user creation account page hosted by the server.

FIG. 4 is a diagram of a shopping cart creation page hosted by the server.

FIG. 5 is a diagram of a product selection page hosted by the server.

FIG. 6 is a diagram of a product detail page hosted by the server.

FIG. 7 is a diagram of a gift bundle selection window hosted by the server.

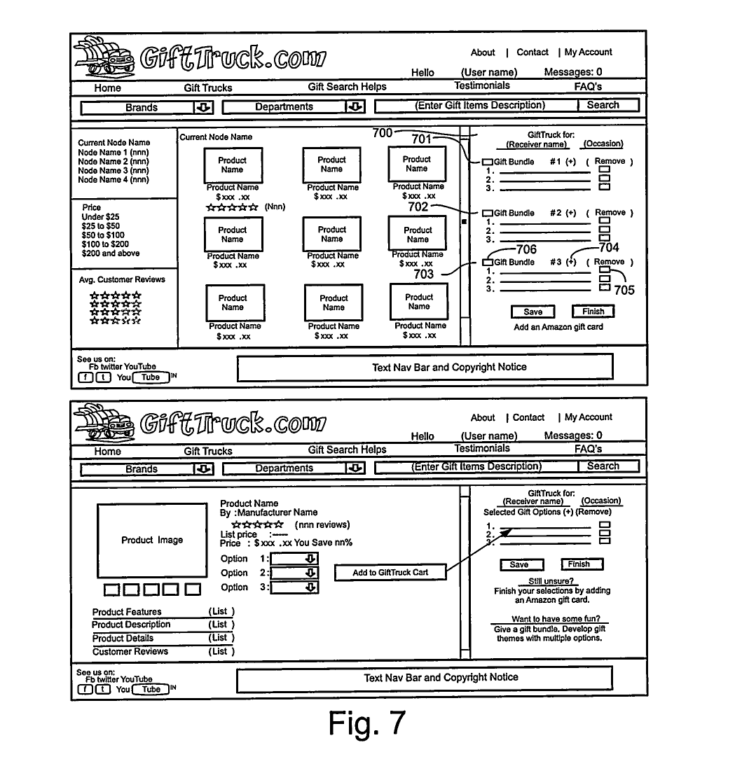

FIG. 8 is a diagram of a gift receiver information screen hosted by the server.

FIG. 9 is a diagram of a gift notice sent by the server.

FIG. 10 is a diagram of a history and final checkout notice sent by the server.

The following call out list of elements can be a useful guide in referencing the elements of the drawings.

### Steps of the Invention

101 Start Gift Giving Process

102 Retrieving Retailer Content

103 Searching For Gifts

104 Preparing Shopping Cart Of Gift Item Candidates

105 Checking Gift Giver Membership

106 Gift Giver User Login

107 Gift Giver Registering And Creating A New Account

108 Checking Gift Receiver Membership

109 Gift Receiver Creating New Account

110 Receiver Choosing From Existing List

118 Sending Gift Notice To Receiver

119 Waiting For Receiver To Choose Gift

120 Receiver Choosing Gift Within A Set Time

121 Sending E-Mail To Gift Giver With Receivers Choice

122 Terminate Kicking Action And Send E-Mail To Gift Giver

123 Receiver Fails To Choose Gift Within A Set Time

124 Resending Gift Notice E-Mail To Receiver

130 Waiting For Giver To Start Checkout

131 Gift Giver Fails To Start Checkout After A Set Time

132 Resending E-Mail To Gift Giver

133 Terminate Gift Action And Send E-Mail To Giver And Receiver

134 Gift Giver Starts Check Out Within Set Time

135 Finalize Retailer External Cart With Chosen Gift

136 Retailer Check Out

137 Sending E-Mail To Giver With Button To Close Out Gifting Cycle

138 Waiting For Gift Giver To Close Out Button

139 Suspending E-Mail Sending Cycle Once Maximum Resend Cycles Are Exceeded

140 Resending E-Mail To Giver If User Fails To Click The Button After A Set Time

141 Changing Status Of Transaction To Closed

142 End Gift Giving Process

201 Create Shopping Cart Button

### User Interface And Server Processes

200 Introductory Website Webpage

201 Create Shopping Cart Button

300 Login Webpage

301 E-Mail Field

302 Password Field

303 Forgotten Password Button

304 Social Media Login

305 Retailer Login

306 New Account Creation

400 Create Shopping Cart Page

401 First Gift Option

402 Second Gift Option

403 Third Selected Gift Option

404 Selected Gift Option Window

405 Save Button

406 Finish Button

407 Imported E-Commerce Retailer Item Information

408 Individual Item Information

409 Remove Item Button

500 Product Selection Page

501 Product Image

502 Product Name

503 Price

504 SKU Number

505 Item Number

506 Size Parameter

507 Color Parameter

508 Shipping Time Parameter

509 Add Item To Shopping Cart Button

600 Product Detail Page

601 Product Features

602 More Comprehensive Product Description

603 Product Specifications

604 Customer Reviews

700 Bundle Selection Window

701 First Gift Bundle

702 Second Gift Bundle

703 A Third Gift Bundle

704 Small Plus Button

705 Item Remove Button

706 Remove Bundle Button

800 Gift Receiver Information Screen

801 History List Selection

802 Send Shopping Cart Button, The Gift Choice Selection Screen Is Finalized.

900 Gift Notice

901 Choice Rule

902 Number Of Gift Choices

903 Shipping Information.

904 Rejection Selection

905 Block Sender Selection

906 Selection Checkboxes T

907 Submit Gift Choice

909 Status

910 Delivery Indication

911 Proceed To Checkout Button

### DETAILED DESCRIPTION OF THE PREFERRED EMBODIMENTS

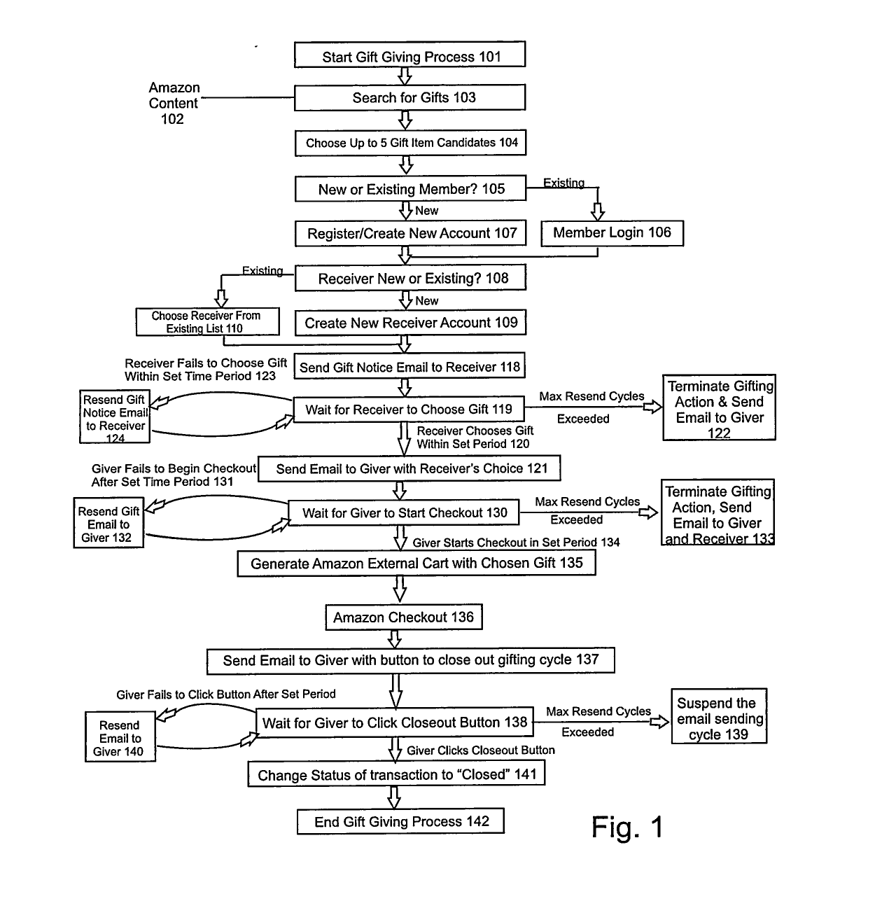

The present invention is a gift search and gift presentation service developed to build consumer confidence in online gift purchasing through the creation of an interactive reverse gift registry which helps gift givers determine what gifts are wanted by their intended recipients prior to gifts being purchased and sent. According to FIG. 1 of the present invention, the user starts the giftgiving process 101 when a user arrives at the gift handling website hosted by the server. The user starts browsing for gifts on the website hosted by the server.

Sometimes a gift giver user will search first because the gift giver user is not already a registered user. Sometimes a gift giver user will login first because the gift giver user is already a registered user. The order of login and searching can be varied. The only time a gift giver user should be required to log in is to save a shopping cart or to submit a shopping cart. Login and registration are optional steps that are preferred.

A user accesses the website and obtains information from ecommerce partnering retailers on an affiliate platform. The gifts are items retrieved from retailers. The server retrieves retailer content 102 in response to a search for gifts 103 conducted by the user. The user can search for gifts by category or by a search query such as a Boolean search query. The retailer content includes a stock keeping unit SKU number, preferably also the model number, name, photograph and description as well as any product reviews or ratings that the item descriptions may come with. The item information is retrieved from retailer content and the gift giver user can preferably choose about five or six gift item candidates. The server then prepares a shopping cart of gift item candidates 104. The server provides gift purchasers with the ability to fill a shopping cart with multiple gift options that will be used to present gift options to gift receivers for them to review and provide feedback regarding what they would most like.

The website also includes information to help gift givers navigate the site as well as search for the right gifts. Gift givers can search through the entire product catalog of partnering retailers to choose items to be presented. Preferably, the gift giver user is able to select up to ten options to present for review. The proposed shopping cart generated by the gift giver has parameters embedded within. Gift giver users are able to create and set of unique parameters for each individual gift recipient. The gift giver initially creates a first shopping cart state.

Gift givers will be able to allow recipients to:
1. Choose a designated number of gifts from the total
   Example: 1 from the total, 2 from the total, 3 from the total, Etc.
2. Choose a “Gift Bundle”
   Gift bundles include 2 or more gift items grouped together. This option requires a minimum of 2 separate gift item choices with at least one of the choices being a bundle.
3. Offer only one item
   Gift givers will be able to present a single item to a recipient if the item has specific options to be chosen. For example an article of clothing will require size and/or color. A golf club may require loft and stiffness. Recipients will be able to select those product variables without requiring multiple gift options.

After creating a proposed shopping cart, the server then checks to see if the gift giver user is a new and existing member. Checking gift giver membership 105 asks the user to go to a member login step 106 if the gift giver is an existing member. The server can also perform the step of creating a new account 107. The server then performs the step of checking gift receiver membership 108. The gift receiver can then creates a new account 109 or the receiver can be chosen from an existing list 110 of registered members.

The server also performs the step of sending a gift to notice to the receiver 118. This can be done by e-mail, regular mail, text message, or by preparing a gift card that the gift giver can print out and give to the gift receiver. The notice can have a QR code or indicia for accessing the gift notice online. When the gift giver completes the selection process he or she is given the opportunity to write a note to accompany the list of items. This information can be saved and returned to at a later date or the gift giver can choose the, “Send” option to inform the gift recipient of the gift choices available. A link is sent to the gift recipient via email, text, etc. or, a card is printed out with the link information listed on it in order for website and account information to be handed/sent to the gift recipient in hard copy. The recipient accesses his/her GiftTruck gift listing where he/she is able to view the gifts selected as well as the note written by the gift giver. The recipient is directed as to what his/her options are and upon review is able to choose the gift(s) like most.

The server then waits for the receiver to choose the gift 119. During waiting for the receiver to choose the gift 119, the receiver can choose the gift within a set time 120 or if the receiver fails to choose the gift within a set time 123, the server can perform the step of resending the gift notice e-mail to receiver 124. If a maximum number of resending cycles is exceeded, the server terminates the gifting action and sends an e-mail to the gift giver 122 giving notice that the receiver has waited too long to choose the gift.

The gift recipient interacts with the gift notice which is linked to the current shopping cart. The gift recipient can customize, or choose the gift. The preference updates the first shopping cart to create a second shopping cart state that may or may not have the same items as the first shopping cart.

The receiver has several options:
1. The receiver can choose to allow the gift giver to choose the gift.
2. The receiver can choose to reject the gift.
3. The receiver can choose one out of several gift possibilities provided by the gift giver.
4. The receiver can choose to customize a gift according to the gift parameters such as color or size.

Optionally, if the gift giver designates that the recipient can choose one gift of the total, the recipient will be given the option of “Surprise Me”. The Surprise Me option allows the gift recipient to choose 2 gifts for the gift giver to make the final choice from. Until the gift arrives the gift recipient will not know what was chosen, thus being surprised when the package arrives. The intended gift recipient also has the ability to reject the gift offer at this time. An option to block the sender completely or for this specific occurrence will be available. Optionally, once the choice has been made, the recipient confirms his shipping address and writes a note of thanks to the gift giver. This information is sent back to GiftTruck.com as well as to the gift giver. The gift giver is linked to the account on the server and automatically linked to the corresponding retailer's checkout.

Once the gift receiver performs the step of choosing the gift within the set time 120, and e-mail is sent to the giver with the receiver's choice 121 as a second shopping cart. The server then waits for the giver to start the checkout 130. The gift giver prepares a third shopping cart state, and has the option to change the second shopping cart however the gift giver chooses. The third shopping cart may or may not be different from the second shopping cart.

The checkout takes place independently of the server. The gift giver is able to complete the transaction on the retailer website. The gift is sent directly to the gift recipient from the retailer. Any questions concerning shipping, terms or returns will be taken up between the gift purchaser and the retailer directly.

If the giver fails to begin checkout after a set time 131, the e-mail is resent to the giver 132. If a maximum number of resending cycles is exceeded, the server terminates the gifting action and it sends an e-mail to the giver and receiver 133. It is expected that the gift giver will start the checkout within a set time 134. When the gift giver starts the checkout within the set time 134, the server performs the next step of generating a retailer external shopping cart with the chosen gift 135. The server then processes the third shopping cart gift order at the retailer check out 136.

After retailer check 136 out the server sends an e-mail to the gift giver with a button to close out the gifting cycle 137. The server waits for the giver to click the close out button 138. If the giver fails to click the button after a set time, the server performs the step of resending the e-mail to the gift giver 140. If a maximum number of resending cycles is exceeded, the server suspends the e-mail sending cycle 139. After the gift giver clicks the close out button, the status of that transaction is set to ‘closed’ 141. This ends the gift giving process 142, preferably with a note or other communication between the gift giver and the gift recipient that is associated with the close out gifting cycle button.

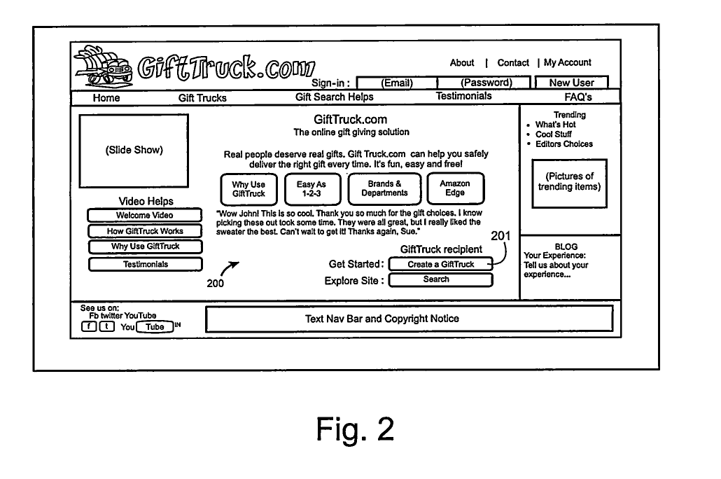

FIG. 2 shows how an introductory website webpage 200 can introduce a user to create a shopping cart. A user can go to a website presented by the server and decide to create a shopping cart by clicking on a create shopping cart button 201. A website webpage can also serve as an introduction to explain the process to a new user who wishes to be a gift giver.

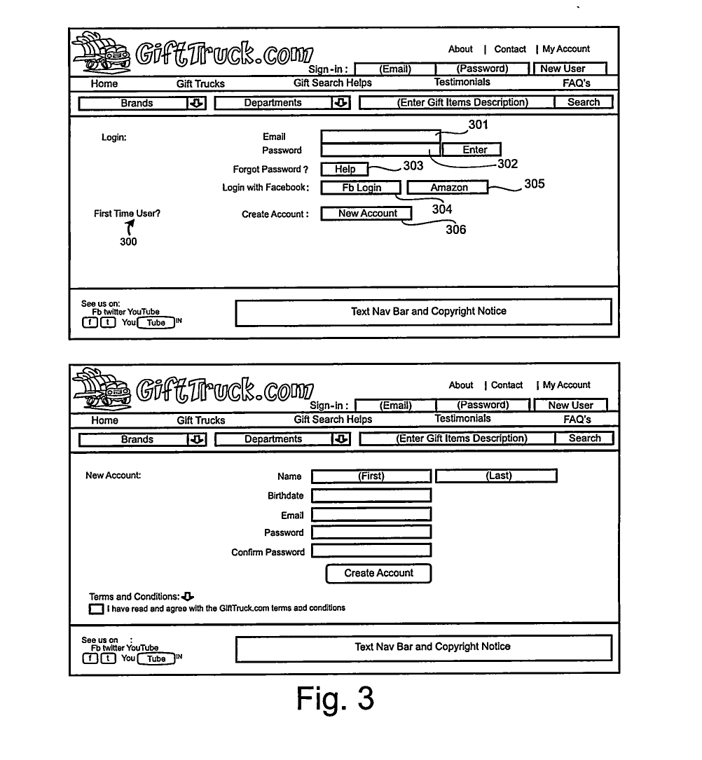

The user may login at a login webpage FIG. 3, 300 or create an account by entering an e-mail into an e-mail field 301. A password can be selected by inputting a password into a password field 302. In case of a forgotten password, a forgotten password routine can be assigned a forgotten password button 303. The user creation account page also provides the possibility for a social media login 304 such as using a Facebook account connection instead of starting a profile from scratch. Alternatively, a user can use a retailer login 305 such as Amazon to use the user's Amazon account. The user can also create a new account on the server by accessing new account creation 306. New account creation 306 is known in the art and should include a first and last name, preferably a birthday, a e-mail, password field and password confirmation field. Terms and conditions are available to the user upon creation of the account.

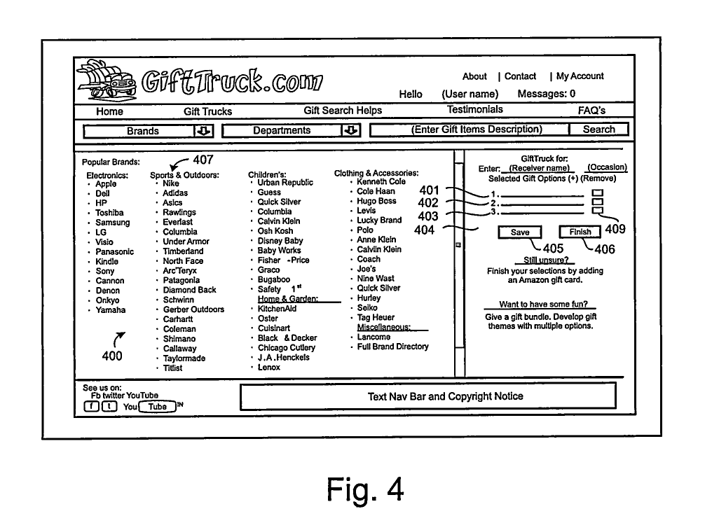

Upon creation of an account, a user can go to a create shopping cart page FIG. 4 , 400. The shopping cart page retrieves item information from other e-commerce retailers and populates the gift selection or item selection in a large list that can be sorted and filtered according to criteria such as brands, departments or by Boolean search. The retrieval of item information can also preserve the e-commerce retailer item descriptions, categories, departments, brands and other types of pre-existing organization. The shopping cart creation page provides multiple options on a selected gift option window 404. The selected gift option window may have a first gift option 401, a second gift option 402, and a third selected gift option 403. After selecting a few items, the user can then save the shopping cart in its first state by clicking a save button 405, or can finish the shopping cart by clicking the finish button 406. The user can also continue to browse the imported e-commerce retailer item information 407. The imported e-commerce retailer information 407 includes categories as well as individual item information. For removing items, a remove item button 409 can be provided to the user by the server.

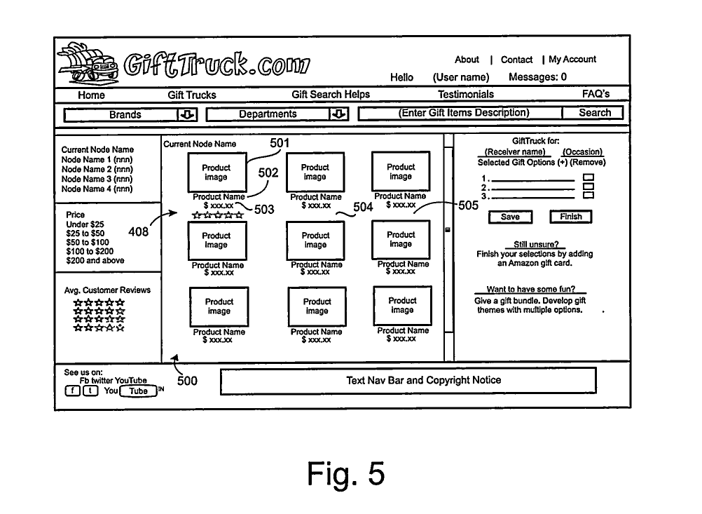

Imported item information can be shown as a product page 500, FIG. 5. The manner of importation of the item information from the e-commerce retailer is by copying the item information, with the consent of the e-commerce retailer. A wide variety of methods can be used to copy the item information, including inputting the item information to a database locally on the server. It is preferred not to copy the entire database locally to the server but rather to reference to the e-commerce retailer information. The server can retrieve dynamically the item information from the e-commerce retailer, which is preferred. Individual item information 408 can include a product image 501, a product name 502, a price 503 and a SKU number 504. The individual item information 408 can also have an item number 505 which may or may not be displayed to the user. The item can be any type of gift, such as a standard consumer product item, a donation to a charity, a clothing item that has color and size parameters, a food item that has allergy information, a virtual item available for a particular server, or a gift card capable of being redeemed online or at a store.

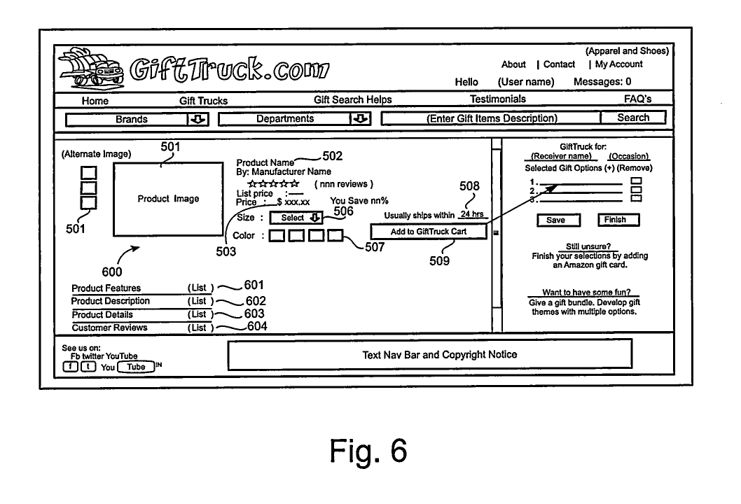

On the product detail page 600, FIG. 6 the product detail may include product features 601, a more comprehensive product description 602, part of specifications 603 and customer reviews 604. The product detail page may dynamically retrieve these product details from the retailer website. The typical shipping time parameter 508 as well as the add item to shopping cart button 509 can be provided to assist a user to shopping cart Along with the product image, the product name and price, secondary attributes such as a size parameter 506 and a color parameter 507 can be preselected by the user at the first shopping cart state.

Instead of individual gifts, the shopping cart can have bundles of gives as an option. A user can access a bundle window 700 and create a first gift bundle 701, a second gift bundle 702, and a third gift bundle 703. A small plus button 704 allows a user to add additional gift bundles and an item remove button 705 allows a user to delete items from a gift bundle. Furthermore, the entire bundle can be deleted by clicking a remove bundle button 706. A user can then save or finish the bundle shopping cart 700.

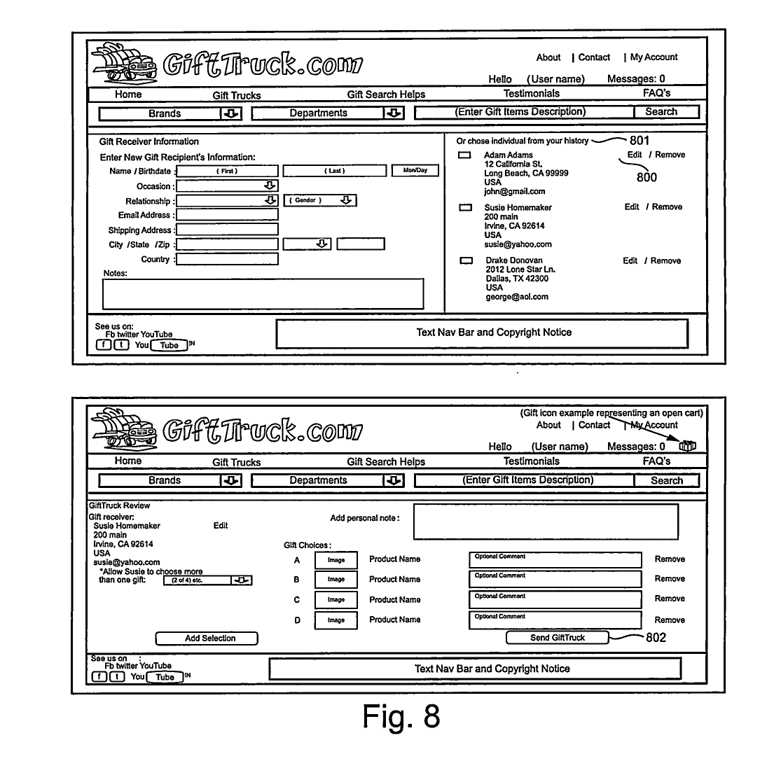

The next screen that a user accesses is a gift receiver information screen 800, FIG. 8. The history list selection 801 allows a user to choose an individual from previous history. The history list selection has a list of previous gift recipients that can be edited. A new gift receiver can be input as well. The gift choices, gift rules and logic can be selected by the user in the gift choice selection screen. Once the user clicks on the send shopping cart button 802, the gift choice selection screen is finalized.

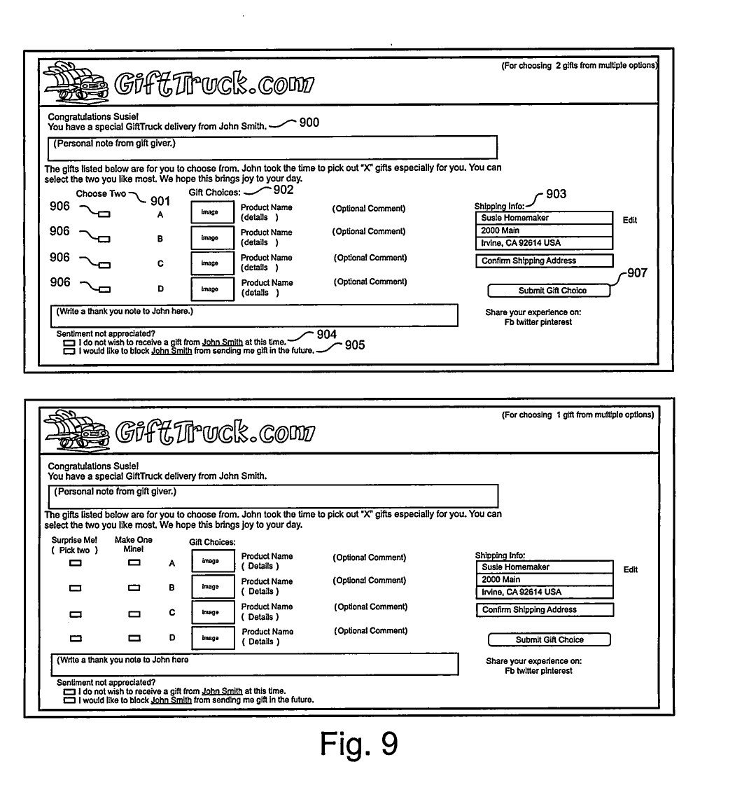

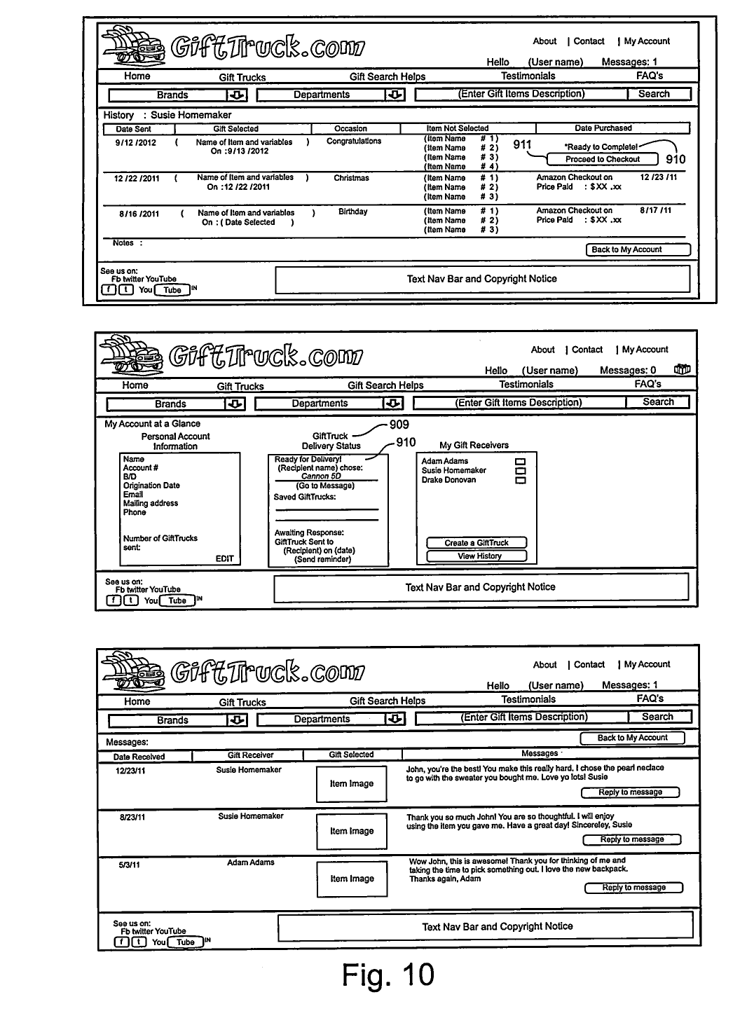

The shopping cart is then sent to the gift recipient as a gift notice 900, FIG. 9. The gift notice provides a choice rule 901, a number of gift choices 902 and additionally optionally shipping information 903. The gift notice 900 may also have a rejection selection 904 and also a block sender selection 905. A user that is the gift recipient may click on selection checkboxes 906 to select or configure the gift choices being provided. When the gift recipient clicks on the submit gift choice 907, the gift recipient modifies the first shopping cart state to the second shopping cart state. The second shopping cart state is then forwarded to the gift giver by e-mail or other electronic notice as a status 909, FIG. 10 with the ready for delivery indication 910. A third shopping cart state is sent to the electronic retailer for processing. The third and final shopping cart state is generated when the user clicks on the ‘proceed to checkout’ button 911. The third shopping cart state is the final shopping cart state and is processed by the retailer immediately upon the submission of the shopping cart to the retailer by a user clicking the proceed to checkout button 911. Additionally, the gift giver can have retrieve and view a list of gifts sent to various persons, and the status of those gifts. Reporting can be generated automatically for tax purposes for a business account for example. Optionally, a feedback page can be provided for messages from the gift recipient to the gift giver so that the gift giver has verification of gift receipt and also personalized feedback regarding the gift. The messages can be organized as an e-mail inbox served by the server.

The following claims define the scope of the invention, and persons of ordinary skill in the art may modify the above teaching. Therefore, while the presently preferred form of the system has been shown and described, and several modifications thereof discussed, persons skilled in this art will readily appreciate that various additional changes and modifications may be made without departing from the spirit of the invention, as defined and differentiated by the following claims.

1. A method of managing an electronic gift shopping cart comprising the steps of:
a. configuring a server to retrieve retailer product information and displaying the retailer product information to a gift giver, the retailer information comprising at least: a product name, a product SKU, and a product description; and presenting the retailer product information to a gift giver user;
b. configuring the server to generate a first shopping cart state by receiving a gift giver gift selection from the retailer product information;
c. configuring the server to configure parameters of the first shopping cart state including the step of providing a choice of a gift to a gift recipient, wherein a plurality of items provides a gift choice;
d. configuring the server to present the first shopping cart state to the gift recipient in the form of a gift notice;
e. configuring the server to receive gift recipient input to modify the first shopping cart state to generate the second shopping cart state based upon the first shopping cart state, wherein the gift recipient provides a gift selection which updates the shopping cart from the first shopping cart state to the second shopping cart state;
f. configuring the server to assign parameters to the second shopping cart state;
g. configuring the server to present the second shopping cart state to the gift giver;
h. configuring the server to receive feedback and a final confirmation from the gift giver;
i. configuring the server to generate a third shopping cart state based upon the second shopping cart state and gift giver feedback;
j. configuring the server to transmit the third shopping cart to the retailer for merchant processing with the retailer's server.

2. The method of managing an electronic gift shopping cart according to claim 1, further comprising the step of: recommending a gift selection to a purchaser based upon prior gift recipient purchasing history.

3. The method of managing an electronic gift shopping cart according to claim 1, further comprising the step of: sending messages from the gift recipient to the gift giver so that the gift giver has verification of gift receipt and also personalized feedback regarding the gift.

4. The method of managing an electronic gift shopping cart according to claim 1, further comprising the step of: allowing the receiver to choose one out of several gift possibilities provided by the gift giver to generate a second shopping cart state.

5. The method of managing an electronic gift shopping cart according to claim 1, further comprising the step of: allowing the receiver to choose to allow the gift giver to choose the gift.

6. The method of managing an electronic gift shopping cart according to claim 1, further comprising the step of: allowing the receiver to reject the gift.

7. The method of managing an electronic gift shopping cart according to claim 1, further comprising the step of: allowing the receiver to customize a gift according to the gift parameters.

8. The method of managing an electronic gift shopping cart according to claim 1, wherein the gift notice is by e-mail.

9. The method of managing an electronic gift shopping cart according to claim 1, wherein the gift notice is by a printed card having gift notice indicia.

10. The method of managing an electronic gift shopping cart according to claim 1, wherein the step of the step of providing a gift choice to a gift recipient involves defining a bundle of items as the gift choice, wherein the gift recipient provides the gift selection which updates the shopping cart from the first shopping cart state to the second shopping cart state.

11. The method of managing an electronic gift shopping cart according to claim 10, further comprising the step of: recommending a gift selection to a purchaser based upon prior gift recipient purchasing history.

12. The method of managing an electronic gift shopping cart according to claim 10, further comprising the step of: sending messages from the gift recipient to the gift giver so that the gift giver has verification of gift receipt and also personalized feedback regarding the gift.

13. The method of managing an electronic gift shopping cart according to claim 10, further comprising the step of: allowing the receiver to choose one out of several gift possibilities provided by the gift giver to generate a second shopping cart state.

14. The method of managing an electronic gift shopping cart according to claim 10, further comprising the step of: allowing the receiver to choose to allow the gift giver to choose the gift.

15. The method of managing an electronic gift shopping cart according to claim 10, further comprising the step of: allowing the receiver to reject the gift.

16. The method of managing an electronic gift shopping cart according to claim 10, further comprising the step of: allowing the receiver to customize a gift according to the gift parameters.

17. The method of managing an electronic gift shopping cart according to claim 10, wherein the gift notice is by e-mail.

18. The method of managing an electronic gift shopping cart according to claim 10, wherein the gift notice is by a printed card having gift notice indicia.
